(19) United States
(12) Patent Application Publication
(10) Pub. No.: US 2009/0049413 A1
(43) Pub. Date: Feb. 19, 2009

(54) Apparatus and Method for Tagging Items

(75) Inventors: Daniel Lehtovirta, Espoo (FI); Sanna Maarit Belitz, Helsinki (FI); Jorma Tapio Suutarinen, Porvoo (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/839,800

(22) Filed: Aug. 16, 2007

(51) Int. Cl. G06F 3/048

(52) U.S. Cl. 715/855

(57) ABSTRACT

A method including presenting an image on a display of a device, automatically providing a tag association menu on the display, the tag association menu being provided with the image, selecting a tag from the tag association menu, the selected tag to be associated with the image and automatically closing the tag association menu.

### BACKGROUND

1. Field

The disclosed embodiments generally relate to user interfaces and, more particularly, to associating tags with items.

2. Brief Description of Related Developments

Mobile devices, such as mobile communication devices, generally include a variety of applications, including for example digital imaging capabilities, email or messaging facilities and media playing facilities. Generally, in conventional devices a user wanting to associate tags, such as informational tags, with items pertaining to the variety of applications navigates through, for example, one or more menus in order to associate a tag with a respective item.

It would be advantageous to be able to associate tags with items in a mobile device in a fast, efficient and easy to use manner.

### SUMMARY

In one aspect, the disclosed embodiments are directed to a method. In one embodiment the method includes presenting an image on a display of a device, automatically providing a tag association menu on the display, the tag association menu being provided with the image, selecting a tag from the tag association menu, the selected tag to be associated with the image and automatically closing the tag association menu.

In another aspect, the disclosed embodiments are directed to an apparatus. In one embodiment the apparatus includes a processor, an input device connected to the processor and a display connected to the processor, wherein the processor is configured to automatically provide a tag association menu on the display in conjunction with a presentation of an image of an image application active in the apparatus, where the tag association menu allows a tag association between the image and a tag without leaving the image application, associate the tag with the image in response to a tag selection and automatically close the tag association menu.

In yet another aspect, the disclosed embodiments are directed to a computer program product embodied in a memory of a device. In one embodiment the computer program product includes a computer useable medium having computer readable code means embodied therein for causing a computer to present a tag association menu. The computer readable code means in the computer program product includes computer readable program code means for causing a computer to present an image on a display of the device, computer readable program code means for causing a computer to automatically provide a tag association menu on the display, the tag association menu being provided with the image, computer readable program code means for causing a computer to select a tag from the tag association menu, the selected tag to be associated with the image and computer readable program code means for causing a computer to automatically close the tag association menu.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIGS. 2 through 6 are illustrations of exemplary screen shots of the user interface in accordance with the disclosed embodiments;

FIG. 7 is a flow chart illustrating one example of a process according to the disclosed embodiments;

FIGS. 8A and 8B are illustrations of examples of devices that can be used to practice aspects of the disclosed embodiments;

FIG. 9 illustrates a block diagram of an exemplary apparatus incorporating features that may be used to practice aspects of the disclosed embodiments; and

FIG. 10 is a block diagram illustrating the general architecture of an exemplary system in which the exemplary devices of FIGS. 8A and 8B may be used.

### DETAILED DESCRIPTION OF THE EMBODIMENT(s)

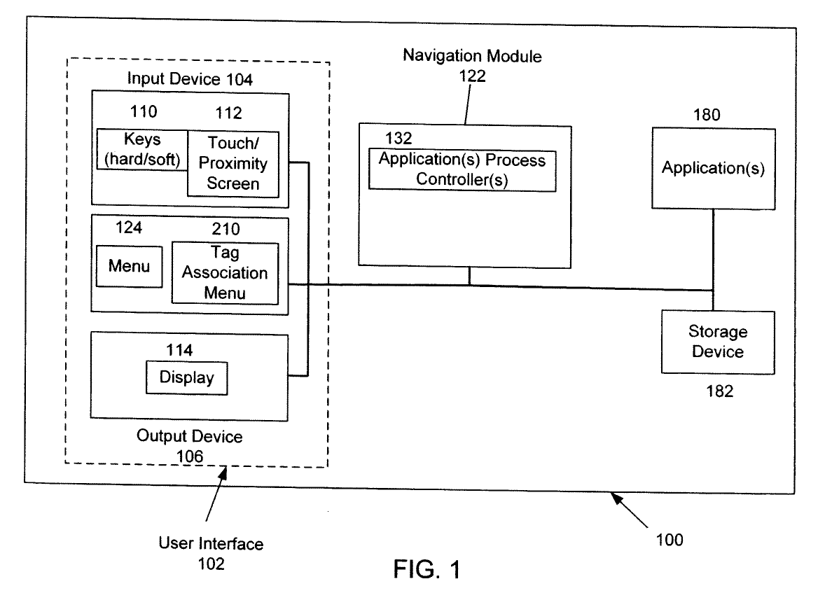

FIG. 1 illustrates one embodiment of a system 100 in which aspects of the disclosed embodiments can be used. Although aspects of the disclosed embodiments will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user of a device or system, such as the system 100 shown in FIG. 1 to associate or add tags to items stored in, acquired by or otherwise present in the system 100 in a fast, efficient and easy to use manner. The tags may be any suitable tags including, but not limited to, informational and identification tags. The items of the device may be any suitable items including, but not limited to, still images, videos (e.g. moving images), sound or music files, email messages, SMS messages and MMS messages. A user causes an item, such as an image, to be presented by the system 100. A tagging tool is then provided that allows the user to apply a tag to the image without leaving or exiting the underlying image application. As will be described in greater detail below, the tagging tool may present predefined tagging options to the user or allow the user to input any suitable customized tag for association with the item.

In one embodiment, referring to FIG. 1, the system can include an input device 104, output device 106, navigation module 122, applications area 180 and storage/memory device 182. The components described herein are merely exemplary and are not intended to encompass all components that can be included in the system 100. For example, in one embodiment, the system 100 comprises a mobile communication device or other such internet and application enabled devices. In one embodiment the applications of the device may include, but are not limited to, data acquisition (e.g. image, video and sound recorders), multimedia players (e.g. video and music players), and any suitable messaging applications (e.g. email, SMS and MMS). Thus, in alternate embodiments, the system 100 can include other suitable devices and applications for monitoring application content and acquiring data and providing communication capabilities in such a device. While the input device 104 and output device 106 are shown as separate devices, in one embodiment, the input device 104 and output device 106 can be part of, and form, the user interface 102. The user interface 102 can be used to display application information such as images, videos, multimedia information, messaging information and allow the user to select items for association with a tag as will be described below.

In one embodiment, the user interface of the disclosed embodiments can be implemented on or in a device that includes a touch screen display or a proximity screen device. In alternate embodiments, the aspects of the user interface disclosed herein can be embodied on any suitable device that will display information and allow the selection and activation of applications. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function. For example, the term “touch” in the context of a proximity screen device, does not imply direct contact, but rather near or close contact, that activates the proximity device.

Similarly, the scope of the intended devices is not limited to single touch or contact devices. Multi-touch devices, where contact by one or more fingers or other pointing devices can navigate on and about the screen are also intended to be encompassed by the disclosed embodiments.

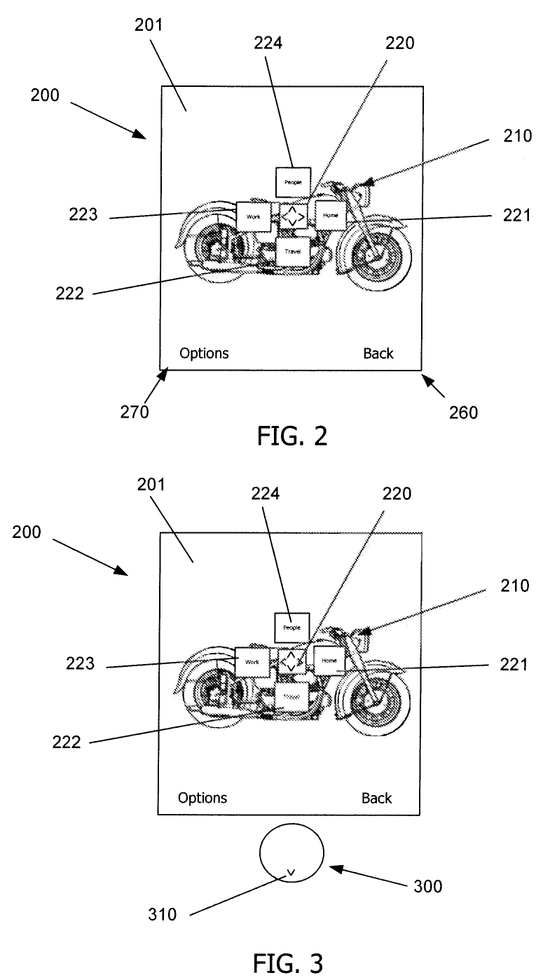

Referring also to FIG. 2, an illustration of a screen shot of a user interface 200 incorporating features of the disclosed embodiments is shown in accordance with one embodiment. The example of FIG. 2 pertains to an imaging application for exemplary purposes only. However, in other embodiments the example shown in FIG. 2 and as described below may be applied to any suitable applications of a device. As shown in FIG. 2, the device acquires an image in any suitable manner including, but not limited to, messaging applications and imaging applications. For exemplary purposes only, in this example the image is acquired through a camera application of the system 100.

As shown in FIG. 2, a tag association menu or tagging tool 210 is caused to appear in conjunction with the image 201. In one embodiment, the tagging tool 210 comprises a pop-up window on the display 114. In alternate embodiments, the tagging tool 210 can be presented or provided on the display 114 in any suitable fashion including, but not limited to, a pop-up window. The tagging tool 210 provides one or more tagging options to the user. In the example of FIG. 2, the tagging options are predefined. In alternate embodiments the tagging tool may be presented aurally through, for example a speaker of the system 100. For example, the tagging tool may be presented as one or more audible voice prompts that present tagging options to a user of the system. Using a navigation key, such as navigation keys 220 or 300 (see FIG. 3), the user can select a tag and apply it to the image. In other embodiments, the user may use speech input to attach a speech or voice tag to the image. In still other embodiments, a user may use speech input to attach a tag to the image where the speech input is converted into text and attached to the image in any suitable manner such as, for example, metadata. The tagging tool can be closed or minimized as will be described below.

In one embodiment, the tagging tool 210 may be in the form of a menu as shown in FIG. 2. The tagging tool 210 is activated, for example, automatically when the item appears on the display or some other manual input. For example, the tagging tool 210 may be manually activated by a multifunction key or substantially touching a touch screen display or proximity screen of the system 100. In this example the tagging tool includes five soft keys 220-224, however it should be realized that the tagging tool 210 may have more or less than five keys corresponding to any suitable number of tags which may be displayed in any suitable arrangement and not necessarily the arrangement shown in FIG. 2. In this embodiment four of the soft keys 221-224 correspond to predetermined or predefined tags while the fifth soft key 220 is a navigation key that allows for the selection of the predefined tags and/or the inputting of user definable or custom tags. The navigation/selection key 200 includes arrows that when selected causes a selection of the corresponding tag (e.g. the tag the arrow points to). The custom tags may be input by selecting the middle or center portion of the key 220.

In other embodiments, any suitable keys (hard keys or soft keys) of the of the system 100 may be used to input tags. For example, numerical keys (0-9) of input device 104 may each correspond to a tag that may be selected by activating a respective one of the keys. It is noted that the hard or soft keys may be located in any suitable area of the system 100. In one embodiment the keys may be located on a touch activated or proximity screen of the system 100. In other embodiments the keys may be located along one or more edges of a display 114 of the system 100.

Activating or selecting a control of the tagging tool 210 generally includes any suitable manner of selecting or activating the controls, including touching, pressing or moving the input device. When the input device 104 includes control 112, which in one embodiment can comprise a touch screen pad or proximity screen, user contact with the touch or proximity screen will provide the necessary input. In one embodiment, where the input device 104 comprises control 110, which in one embodiment can comprise a device having a keypad, pressing a key can activate a function. In other embodiments, where the control 110 of input device 104 also includes a multifunction rocker style switch or joystick 300 as shown in FIG. 3, the switch 300 can be used to select a menu item and/or select or activate the tagging tool controls in a manner substantially similar to that described above. It is noted that the multifunction key 300 may also include arrows (one of which is shown in FIG. 3 as reference number 310) and allow for custom tag inputs by activating a center portion of the key or joystick 300. In alternate embodiments the tagging keys 220-224 may be activated in any suitable manner. Voice commands and other touch sensitive input devices can also be used.

It is noted that while the embodiments are described has having four tag keys 221-224 that are be accessed through, for example, a four-way navigation key (e.g. the key can select items when the key is activated in, for example an up/down/left/right direction and/or by pressing the center of the key) the embodiments described herein are not limited to use with the four-way navigation key. For example, in alternate embodiments, the tag functions may be selected with a rotatable selector, a slidable selector and/or a multi-key selector (e.g. configured for pressing/holding down one button while using another key such as a multifunction key). In other alternate embodiments the navigation key may have more or less than four activatable positions.

The predefined tags 221-224 may be defined in any suitable manner. In one embodiment the predefined tags 221-224 may be defined through, for example, any suitable menu of the system 100 such as a settings menu. The menu may be any suitable menu for allowing a user to associate any suitable tag information with a respective one of the tag keys 221-224. For exemplary purposes only, as can be seen in FIG. 2, the tags “home,” “travel, “work” and “people” are respectively associated with tag keys 221-224. Here the tags include words but in other embodiments the tags may include any suitable characters, words, phrases, images (e.g. still or moving) and/or sounds. In the example shown in FIG. 2, the tag keys represent “real tags” where the words presented on the tag key represent the tag that will be associated with the image 201. In still other embodiments, one or more of the tag keys 221-224 can open up a sub-list or menu of other tags that may be selected by the user. For example, if the “people” tag key 224 is activated a list of people may appear. The list of people may include any suitable tags such as, for example, the most frequent people tags and/or additional tag keys that present additional user options such as the presentment of additional people tags (e.g. a “more people” tag key). In alternate embodiments tags may be predefined during the manufacturing of the device or in any other suitable manner. In alternate embodiments, the tagging tool may be in the form of programmable hard keys of the device.

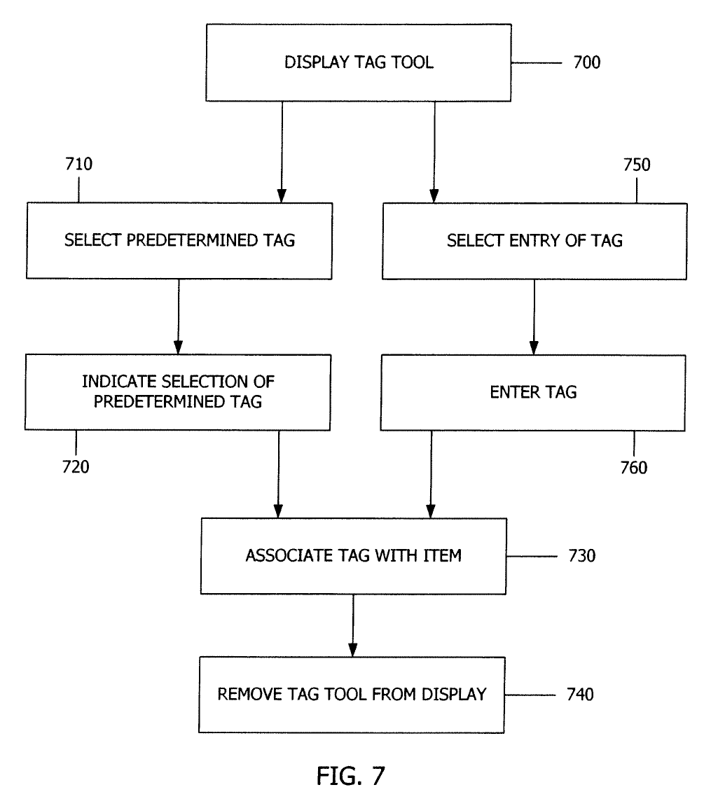

The tagging tool 210 may be presented on the display of the system 100 at any suitable time and in any suitable manner (FIG. 7, Block 700). In one embodiment, the tagging tool 210 may automatically be displayed when an item appears on the display of the system 100. For example, when an image is acquired by, for example, a camera of the device the tagging tool 210 may be presented along with the image. As can be seen in FIG. 2, the tagging tool 210 may be presented as a pop up menu that is presented over the image. The tagging tool 210 may be suitably sized, colored (or lack of color) and positioned on the display so that a user of the system 100 will not be distracted by the tagging tool 210 if the user chooses to ignore the tool 210. In one embodiment the tagging tool 210 may be substantially transparent allowing the user to see the image through the tagging tool 210. The transparency of the tagging tool 210 may be user adjustable through, for example any suitable menu or keys of the system 100. In alternate embodiments, the display of the device may be split between the image and the tagging tool 210 such that the image is resized when the tagging tool 210 is presented on the display. In other alternate embodiments the tagging tool 210 may be presented on the display upon demand such as when a predefined key is activated or the touch screen display is substantially contacted (e.g. substantially contacted anywhere on the display or at a predetermined area of the display).

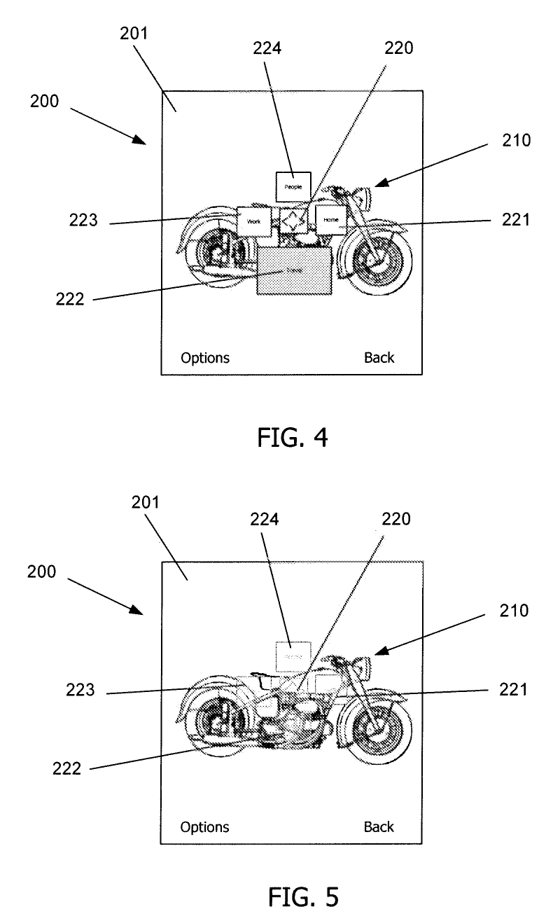

In this embodiment, one of the predefined tags, such as tag 222, is selected (FIG. 7, Block 710). Referring now to FIG. 4, when a tag is selected the system 100 may provide an indication as to which tag is selected by, for example, changing an appearance of the selected tag (FIG. 7, Block 720). For example, as can be seen in FIG. 4, the tag 222 is enlarged to indicate it is selected. In other examples any suitable indication that the tag is selected may be employed including, but not limited to, giving the tag a raised appearance, highlighting the tag, changing a color and/or transparency of the tag, shrinking the tag and causing the tag to blink or move. In one embodiment, when the tag is selected the device associates the tag with the item (FIG. 7, Block 730). In other embodiments the tag association may be made after a predetermined amount of time lapses after the tag key is activated such that the user has an opportunity to re-select another tag if the user selected and undesired tag. The tag tool 210 is minimized on the display, removed or otherwise hidden from the display in any suitable manner after the association is made (FIG. 7, Block 740). Referring to FIG. 5, in one example, after the association is made the tag tool 210 may be faded on the display such that the transparency of the tag tool 210 is maximized providing a substantially unimpaired view of the display. In other examples, the tag tool 210 may be removed from the display abruptly or gradually by increasing the transparency of the tool 210 until the tool disappears from the display.

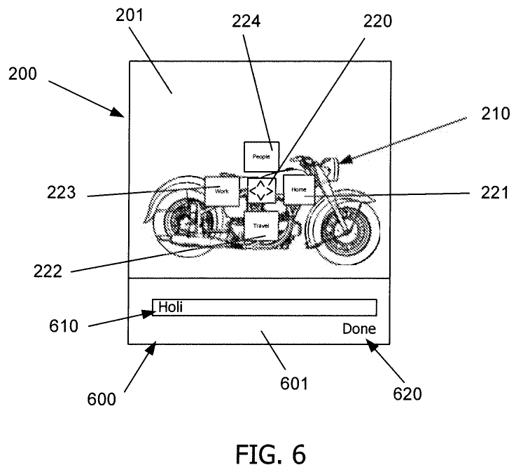

In another example, a customized or user defined tag can be associated with the item by activating the tag key 220. In this example a center region of, for example, the tag key 220 is activated to open a custom tag or manual tag input application 600 (FIG. 7, Block 750). In one embodiment, the tag input application 600 includes a tag input area 601 and one or more soft keys 620. In alternate embodiments the tag input application 600 may have any suitable configuration. As can be seen in FIG. 6, the tag input area 601 may be presented in any suitable area of the display and in any suitable manner. The tag input area 601 is shown along a bottom of the display in FIG. 6 for exemplary purposes only. In one embodiment, the image may be resized when the tag input area 601 is presented. In other embodiments the tag input area 601 may be presented over the image in any suitable manner including, but not limited to, a manner substantially similar to that described above with respect to the tag keys 220-224. The tag input area 601 may include a tag entry section 610. Any suitable tag may be entered with any suitable input of the user interface 102 (FIG. 7, Block 760) and displayed in, for example, the tag entry section 610 to give the user feedback as to what characters or other input are entered. In alternate embodiments, any suitable data may be input as a tag including, but not limited to, images, videos and sounds, which may be accessed through, for example, soft keys, menus or in any other suitable manner. When the custom or user defined tag is input it may be associated with the item by for example, activating a key or substantially touching an area of a touch screen of the system 100. In this example, the user defined tag may be associated with the item by activating the soft key 620 but in alternate embodiments the association may be made in any suitable manner. When the association is made the tag tool 210 may be closed, minimized or otherwise removed from the display in a manner substantially similar to that described above with respect to the tag keys 220-224.

It is noted that in one embodiment, where the tag tool 210 is not activated (after it appears on the display) the tag tool 210 may be closed, minimized or otherwise removed from the display in a manner that is substantially similar to that described above. For example, after a predetermined amount of time, if none of the tag keys 220-224 are activated (e.g. the user ignores the tag key menu), the tag tool 210 may be close, removed or minimized. In other examples, there may be a key that when pressed/activated causes the tag tool 210 to be removed or minimized. When the tag tool 210 is closed, minimized or removed the tag tool 210 waits or remains running/active in, for example, the background of the system 100 so that the tag tool can be reactivated in any suitable manner to change a tag association or to create a new tag association. For example, the tag tool 210 may be reactivated by activating a predetermined hard or soft key of the system 100 or by substantially touching an area of a touch screen or proximity of the system 100. In one example the tag tool may be reactivated through soft key 260 or 270 (FIG. 2). The tag tool 210 may also be automatically reactivated when, for example, a new picture is taken with a camera of the system or when a new message is received. In other embodiments the tag tool 210 may be reactivated through any suitable menu of the system 100. In alternate embodiments, the tag tool 210 may not run in the background but be started upon a reactivation event as described above.

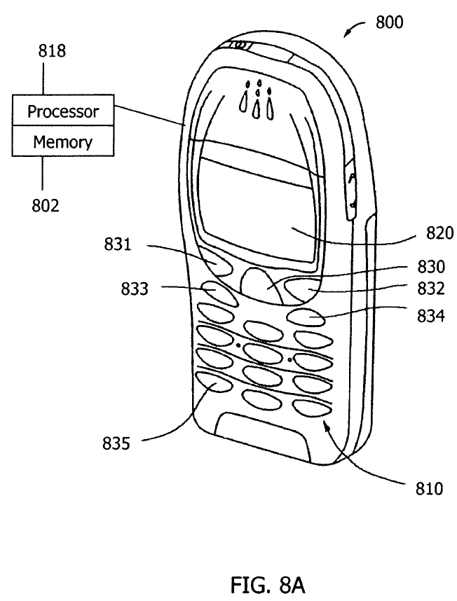

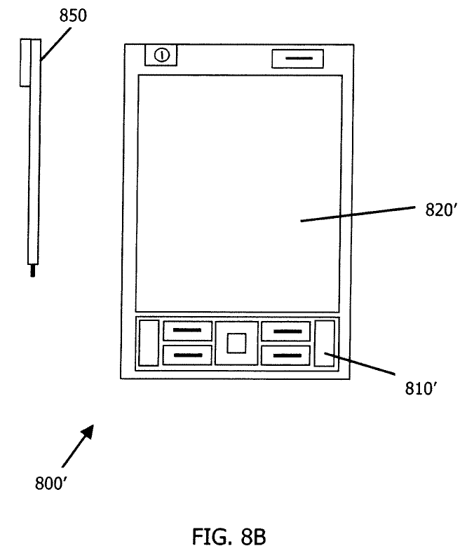

Examples of devices on which aspects of the disclosed embodiments can be practiced are illustrated with respect to FIGS. 8A and 8B. The terminal or mobile communications device 800 may have a keypad 810 and a display 820. The keypad 810 may include any suitable user input devices such as, for example, a multi-function/scroll key 830, soft keys 831, 832, a call key 833, an end call key 834 and alphanumeric keys 835. The display 820 may be any suitable display, such as for example, a touch screen display or graphical user interface. The display may be integral to the device 800 or the display may be a peripheral display connected to the device 800. A pointing device, such as for example, a stylus, pen or simply the user's finger may be used with the display 820. In alternate embodiments any suitable pointing device may be used. In other alternate embodiments, the display may be a conventional display. The device 800 may also include other suitable features such as, for example, a camera, loud speaker, connectivity port or tactile feedback features. The mobile communications device may have a processor 818 connected to the display for processing user inputs and displaying information on the display 820. A memory 802 may be connected to the processor 818 for storing any suitable information and/or applications associated with the mobile communications device 800 such as phone book entries, calendar entries, etc.

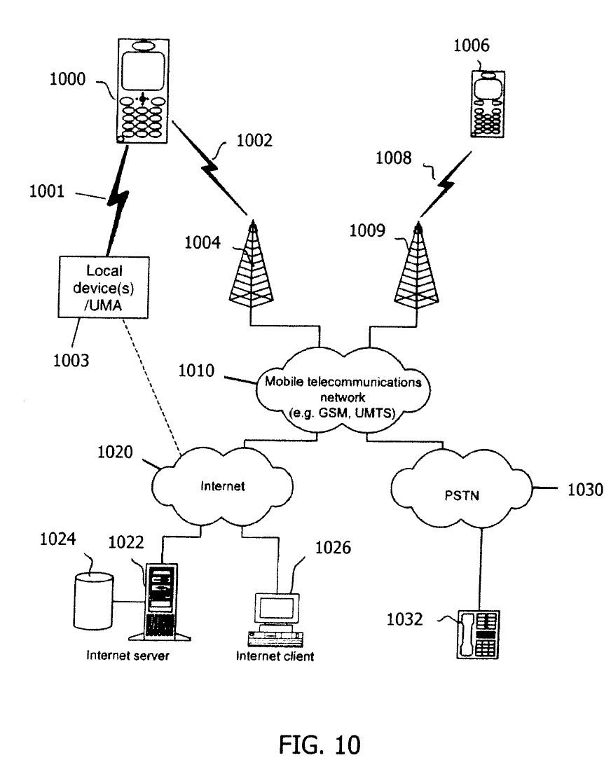

In the embodiment where the device 800 comprises a mobile communications device, the device can be adapted to communication in a telecommunication system, such as that shown in FIG. 10. In such a system, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 1000 and other devices, such as another mobile terminal 1006, a line telephone 1032, a personal computer 1051 or an internet server 1022. It is to be noted that for different embodiments of the mobile terminal 1000 and in different situations, some of the telecommunications services indicated above may or may not be available. The aspects of the disclosed embodiments are not limited to any particular set of services in this respect.

The mobile terminals 1000, 1006 may be connected to a mobile telecommunications network 1010 through radio frequency (RF) links 1002, 1008 via base stations 1004, 1009. The mobile telecommunications network 1010 may be in compliance with any commercially available mobile telecommunications standard such as for example GSM, UMTS, D-AMPS, CDMA2000, (W)CDMA, WLAN, FOMA and TD-SCDMA.

The mobile telecommunications network 1010 may be operatively connected to a wide area network 1020, which may be the internet or a part thereof. An internet server 1022 has data storage 1024 and is connected to the wide area network 1020, as is an internet client computer 1026. The server 1022 may host a www/wap server capable of serving www/wap content to the mobile terminal 1000.

A public switched telephone network (PSTN) 1030 may be connected to the mobile telecommunications network 1010 in a familiar manner. Various telephone terminals, including the stationary telephone 1032, may be connected to the PSTN 1030.

The mobile terminal 1000 is also capable of communicating locally via a local link 1001 or 1051 to one or more local devices 1003 or 1050. The local links 1001 or 1051 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1003 can, for example, be various sensors that can communicate measurement values to the mobile terminal 1000 over the local link 1001. The above examples are not intended to be limiting, and any suitable type of link may be utilized. The local devices 1003 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 1000 may thus have multi-radio capability for connecting wirelessly using mobile communications network 1010, WLAN or both. Communication with the mobile telecommunications network 1010 may also be implemented using WiFi, WiMax, or any other suitable protocols, and such communication may utilize unlicensed portions of the radio spectrum (e.g. unlicensed mobile access (UMA)). In one embodiment, the navigation module 122 of FIG. 1 can include a communications module that is configured to interact with the system described with respect to FIG. 10.

In one embodiment, the system 100 of FIG. 1 may be for example, a PDA style device 800′ illustrated in FIG. 8B. The PDA 800′ may have a keypad 810′, a touch screen display 820′ and a pointing device 850 for use on the touch screen display 820′. In still other alternate embodiments, the device may be a personal communicator, a tablet computer, a laptop or desktop computer, a television or television set top box, or any other suitable device capable of containing a display such as display 820′ and supported electronics such as a processor and memory. Although the exemplary embodiments are described with reference to the mobile communications devices 800, 800′ for exemplary purposes only and it should be understood that the embodiments could be applied equally to any suitable device incorporating a display, processor, memory and supporting software or hardware.

The user interface 102 of FIG. 1 can also include menu systems 124, 210 in the navigation module 122. The navigation module 122 provides for the control of certain processes of the system 100 including, but not limited to the navigation controls for the tag association menu 210. The menu system 124 can provide for the selection of different tools and application options related to the applications or programs running on the system 100. In one embodiment, the menu system 124 may provide for the selection of the tag association menu 210 or features associated with the tag association menu 210 such as setting features for predefining the tags. In the embodiments disclosed herein, the navigation module 122 receives certain inputs, such as for example, signals, transmissions, instructions or commands related to the functions of the system 100, such as the tagging tool. Depending on the inputs, the navigation module interprets the commands and directs the process control 132 to execute the commands accordingly.

Although the above embodiments are described as being implemented on and with a mobile communication device, it will be understood that the disclosed embodiments can be practiced on any suitable device. For example, the system 100 of FIG. 1 can generally comprise any suitable electronic device, such as for example a personal computer, a personal digital assistant (PDA), a mobile terminal, a mobile communication terminal in the form of a cellular/mobile phone, or a multimedia device or computer. In alternate embodiments, the system 100 of FIG. 1 may be a personal communicator, a mobile phone, a tablet computer, touch pad device, Internet tablet, a laptop or desktop computer, a television or television set top box a DVD or High Definition player or any other suitable device capable of containing for example a display 114 shown in FIG. 1, and supported electronics such as the processor 818 and memory 802 of FIG. 8. For description purposes, the embodiments described herein will be with reference to a mobile communications device for exemplary purposes only and it should be understood that the embodiments could be applied equally to any suitable device incorporating a display, processor, memory and supporting software or hardware.

Referring to FIG. 1, the display 114 of the system 100 can comprise any suitable display, such as noted earlier, a touch screen display, proximity screen device or graphical user interface. In one embodiment, the display 114 can be integral to the system 100. In alternate embodiments the display may be a peripheral display connected or coupled to the system 100. A pointing device, such as for example, a stylus, pen or simply the user's finger may be used with the display 114. In alternate embodiments any suitable pointing device may be used. In other alternate embodiments, the display may be any suitable display, such as for example a flat display 114 that is typically made of an LCD with optional back lighting, such as a TFT matrix capable of displaying color images. A touch screen may be used instead of a conventional LCD display.

The system 100 may also include other suitable features such as, for example, a camera, loudspeaker, connectivity port or tactile feedback features.

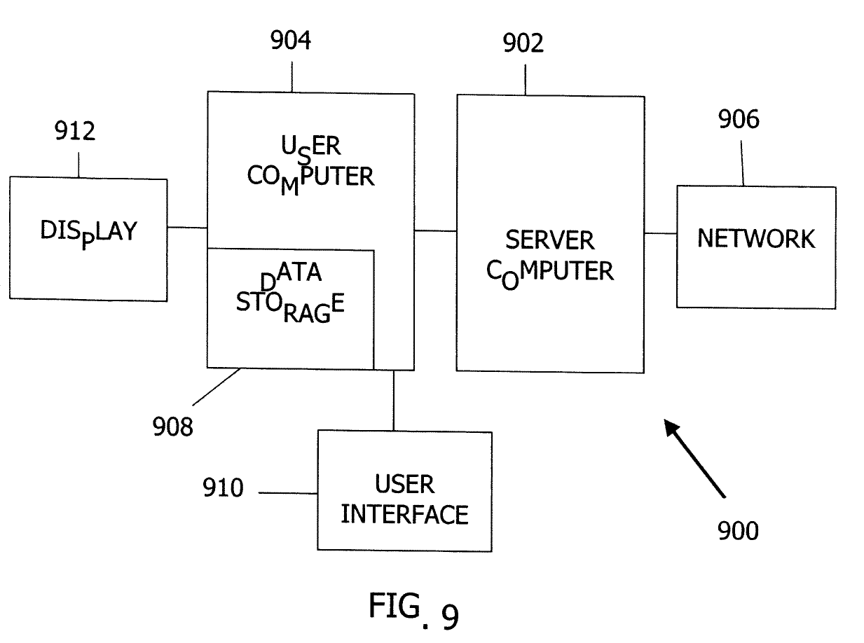

The disclosed embodiments may also include software and computer programs incorporating the process steps and instructions described above that are executed in different computers. FIG. 9 is a block diagram of one embodiment of a typical apparatus 900 incorporating features that may be used to practice aspects of the invention. The apparatus 900 can include computer readable program code means for carrying out and executing the process steps described herein. As shown, a computer system 902 may be linked to another computer system 904, such that the computers 902 and 904 are capable of sending information to each other and receiving information from each other. In one embodiment, computer system 902 could include a server computer adapted to communicate with a network 906. Computer systems 902 and 904 can be linked together in any conventional manner including, for example, a modem, wireless, hard wire connection, or fiber optic link. Generally, information can be made available to both computer systems 902 and 904 using a communication protocol typically sent over a communication channel or through a dial-up connection on ISDN line. Computers 902 and 904 are generally adapted to utilize program storage devices embodying machine-readable program source code, which is adapted to cause the computers 902 and 904 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 902 and 904 may also include a microprocessor for executing stored programs. Computer 902 may include a data storage device 908 on its program storage device for the storage of information and data. The computer program or software incorporating the processes and method steps incorporating aspects of the invention may be stored in one or more computers 902 and 904 on an otherwise conventional program storage device. In one embodiment, computers 902 and 904 may include a user interface 910, and a display interface 912 from which aspects of the invention can be accessed. The user interface 910 and the display interface 912 can be adapted to allow the input of queries and commands to the system, as well as present the results of the commands and queries.

The disclosed embodiments generally allow a user to associate or add tags to items stored in, acquired by or otherwise present in a device in a fast, efficient and easy to use manner. A tag menu automatically presented in conjunction with the item. A predefined tag is selected from the tag menu or a customized tag is input for association with the item. The tags may be associated with an item without leaving an underlying application which may make the use of the device more efficient as the user can add a tag to an item and quickly return to the application without having to navigate through various menus.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
presenting an image on a display of a device;
automatically providing a tag association menu on the display, the tag association menu being provided with the image;
selecting a tag from the tag association menu, the selected tag to be associated with the image; and
automatically closing the tag association menu.

2. The method of claim 1, wherein automatically providing the tag association menu further comprises:
detecting a presence of the image on the display; and
providing a pop-up window on the display, the pop-up window including at least one tag item and a navigation control that allows a user to indicate a selection of one of the tag items.

3. The method of claim 1, wherein the tag association menu comprises one or more predefined tag keys and selecting the tag comprises selecting a predefined tag from the tag keys.

4. The method of claim 1, wherein selecting the tag comprises:
selecting an input field function from a navigation control of the tag association menu; and
inputting a customized tag entry as the selected tag.

5. The method of claim 1, further comprising providing feedback indicating that a tag is selected.

6. The method of claim 1, wherein the tag association menu is transparently displayed over the application item.

7. The method of claim 1, where closing the tag association menu comprises:
detecting an interval of no activity with the tag association menu after the tag association menu is provided on the display; and
closing the tag association menu.

8. The method of claim 1, wherein closing the tag association menu comprises activating a key on the device to close or minimize the tag association menu.

9. The method of claim 1, further comprising re-presenting the tag association menu on the display in response to a predetermined condition.

10. An apparatus comprising:
a processor;
an input device connected to the processor; and
a display connected to the processor;
wherein the processor is configured to:
automatically provide a tag association menu on the display in conjunction with a presentation of an image of an image application active in the apparatus, where the tag association menu allows a tag association between the image and a tag without leaving the image application;
associate the tag with the image in response to a tag selection; and
automatically close the tag association menu.

11. The apparatus of claim 10, where the processor is further configured to:
detect a presence of the image on the display; and
provide a pop-up window on the display, the pop-up window including at least one tag item and a navigation control that allows a user to indicate a selection of one of the tag items.

12. The apparatus of claim 10, wherein the tag association menu comprises one or more predefined tag keys and the tag selection comprises:
selection of a predefined tag from the tag keys of the tag association menu; or
selection of an input field function from a navigation control of the tag association menu and inputting a customized tag entry as the selected tag.

13. The apparatus of claim 10, wherein the processor is further configured to provide feedback indicating that a tag is selected.

14. The apparatus of claim 10, wherein the tag association menu is transparently displayed over the application item.

15. The apparatus of claim 10, wherein the processor is further configured to close the tag association menu in response to a detection of an interval of no activity with the tag association menu after the menu is provided on the display.

16. The apparatus of claim 10, wherein the processor is further configured to close or minimize the tag association menu in response to an activation of a key on the apparatus.

17. The apparatus of claim 10, wherein the tag association menu closed by a fading of the tag association menu.

18. The apparatus of claim 10, wherein the processor is further configured to allow a re-presenting of the tag association menu on the display in response to a predetermined condition.

19. The apparatus of claim 10, wherein the apparatus is a mobile communication device.

20. A computer program product embodied in a memory of a device comprising:
a computer useable medium having computer readable code means embodied therein for causing a computer to present a tag association menu, the computer readable code means in the computer program product comprising:
computer readable program code means for causing a computer to present an image on a display of the device;
computer readable program code means for causing a computer to automatically provide a tag association menu on the display, the tag association menu being provided with the image;
computer readable program code means for causing a computer to select a tag from the tag association menu, the selected tag to be associated with the image; and
computer readable program code means for causing a computer to automatically close the tag association menu.

21. The computer program product of claim 20, further comprising:
computer readable program code means for causing a computer to detect a presence of the image on the display; and
computer readable program code means for causing a computer to provide a pop-up window on the display, the pop-up window including at least one tag item and a navigation control that allows a user to indicate a selection of one of the tag items.

22. The computer program product of claim 20, wherein the tag selection comprises:
selection of a predefined tag from the tag keys of the tag association menu; or
selection of an input field function from a navigation control of the tag association menu and inputting a customized tag entry as the selected tag.

23. The computer program product of claim 20, further comprising computer readable program code means for causing a computer to allow a re-presenting of the tag association menu on the display in response to a predetermined condition.
